(19) United States
(12) Patent Application Publication
(10) Pub. No.: US 2013/0013503 A1
(43) Pub. Date: Jan. 10, 2013

(54) SYSTEMS AND METHODS FOR FACILITATING TRANSACTIONS

(76) Inventor: Patrick BOUAZIZ, New York, NY (US)

(21) Appl. No.: 13/542,232

(22) Filed: Jul. 5, 2012

Related U.S. Application Data
(60) Provisional application No. 61/504,598, filed on Jul. 5, 2011.

(51) Int. Cl. G06Q 20/40; G06F 21/00; G06Q 20/18

(52) U.S. Cl. 705/43; 705/44; 726/2; 726/5

(57) ABSTRACT

Systems and methods for facilitating transactions are disclosed. A system includes a hardware component, a software component adapted to run on at least in part on the hardware component, and an information component adapted to be accessed by the software component. The hardware component includes a biometric fingerprint reader, a user-operable button, indicator LEDs, a connector or a wireless communication device, and a Secure Access Module. A method for performing a face-to-face payment operation from a customer to a retailer includes presenting the system to the retailer, initiating reading of information from a retailer system, activating the system by entering fingerprint information using a fingerprint reader, transferring information to the retailer system, validating the transfer of information to the retailer system, and completing the face-to-face payment operation.

This application claims the benefit of U.S. Provisional Patent Application No. 61/504,598, filed on Jul. 5, 2011, and entitled, “System, method and apparatus to process secure cashless transactions and other proximity applications,” which is incorporated herein by reference in its entirety.

### BACKGROUND

In modern retail environments, the use of payment cards, such as credit cards, debit cards, with or without IC, presents a number of limitations and points of vulnerability. First, the identification of the purchaser is not systematic. Further, sensitive information, such as the cardholder's name, the card number, the expiration date, and the CVV code, is embossed and visible on the card. The use or fraudulent operation of the card by a third party is also possible. Furthermore, the use or fraudulent operation of the card is possible after the card is lost.

E-commerce transactions that rely on the use of payment cards are vulnerable to the limitations and points of vulnerability described above. Moreover, the transfer of data through retail checkout forms can be painstaking: about 25% of online shoppers abandon their order due to frustration while filling out forms.

Furthermore, wireless communication technology, such as Near Field Communication (NFC), is intended mainly for use with mobile phones. Accordingly, access to that technology by the general public is subject to a cost barrier.

### SUMMARY

An exemplary embodiment of a system for facilitating transactions may include a hardware component, a software component adapted to run on at least in part on the hardware component, and an information component adapted to be accessed by the software component. The hardware component may include at least one biometric fingerprint reader, at least one user-operable button, a plurality of indicator LEDs, at least one of a connector and a wireless communication device, and at least one Secure Access Module.

An exemplary embodiment of a method for setting up and locking a system for facilitating transactions may include injecting an encryption key, entering pertinent information, entering fingerprint information, and locking the system. The pertinent information may include information useful for at least one of a payment operation and a wireless transaction.

An exemplary method for performing a face-to-face payment operation from a customer to a retailer using a system for facilitating transactions may include presenting the system to the retailer, initiating reading of information from a retailer system, activating the system by entering fingerprint information using a fingerprint reader, transferring information to the retailer system, validating the transfer of information to the retailer system, and completing the face-to-face payment operation. The retailer system may include at least one of a connector-compatible device and a wireless-enabled device.

An exemplary method for performing a financial operation at a cash point machine using a system for facilitating transactions may include connecting the system to the cash point machine, activating data transmission to the cash point machine by entering fingerprint information using a fingerprint reader, and completing the financial operation. The cash point machine may include at least one of a connector-compatible device and a wireless-enabled device.

An exemplary method for performing a payment operation on an Internet website payment gateway using an Internet-connected system and a system for facilitating transactions may include connecting the system to the Internet-connected system, activating data transmission to the payment gateway through the Internet-connected system by entering fingerprint information using a fingerprint reader, validating the payment operation, and completing the financial operation. The Internet-connected system may include at least one of a connector-compatible device and a wireless-enabled device.

### BRIEF DESCRIPTION OF THE DRAWINGS

The present embodiments are illustrated by way of example and not limitation in the figures of the accompanying drawings, in which like references indicate similar elements.

FIG. 1 illustrates an exemplary embodiment of a computer system.

FIG. 2 illustrates a logical description of three main components of an exemplary embodiment of a system for facilitating transactions.

FIG. 3 illustrates a detailed drawing of an exemplary embodiment of the hardware component of a system for facilitating transactions.

FIG. 4 illustrates a detailed drawing of another exemplary embodiment of the hardware component of a system for facilitating transactions.

FIG. 5 illustrates a logical description of another exemplary embodiment of the hardware component group of a system for facilitating transactions.

FIG. 6 illustrates a logical description of the system architecture of another exemplary embodiment of a system for facilitating transactions.

FIG. 7 illustrates an exemplary method of setting up and locking the system for facilitating transactions.

FIG. 8 illustrates an exemplary method of performing a face-to-face payment operation with a retailer.

FIG. 9 illustrates an exemplary method of performing a financial operation at a cash point machine.

FIG. 10 illustrates an exemplary method of performing a payment operation on an Internet website.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein can provide systems and methods for facilitating transactions. The embodiments disclosed herein may employ, for example, cash substitutes, and may allow users to make commerce transactions faster and more securely than with traditional payment systems, such as drafts, credit cards, debit cards, documentary credit, and electronic fund transfers. The embodiments disclosed herein may also enhance reliability in the use of cashless payment systems, such as credit cards, debit cards, and e-commerce.

In addition to payment functions, the embodiments disclosed herein can provide compatibility with applications in which customer identification is required and ownership of privilege is critical. These applications may include electronic ticketing of airline tickets, concert/event tickets, and others, electronic money transfers, providing travel cards, providing identity documents, and providing electronic keys, as replacements for physical keys.

The embodiments disclosed herein may also improve the purchaser's identification at the time of a transaction, accelerate the check-out procedure, enable the use of wireless technology for various applications, and provide the purchaser with a real opportunity for a digital wallet or an e-wallet.

Embodiments of systems and methods disclosed herein may include fingerprint reading. A fingerprint reader may scan a finger or a thumb and may only store data concerning distinctive portions of a fingerprint called “minutia points.” A complete image of the fingerprint itself may therefore never be stored on a system. The minutia points are only a mathematical representation of some data from the original fingerprint. It may not be possible to reconstruct the fingerprint using these points. In addition, these templates may be encrypted when stored. The encryption of the templates may be an independent element and may thus not depend on the security software.

Embodiments of systems and methods disclosed herein may include the processing of payment transactions. Embodiments may be backed by one or more accounts holding funds belonging to an owner of an embodiment of a system, or offering credit to a system user.

Embodiments disclosed herein may provide a simplified approach to completing transaction, and may result in better usability and ultimately more utility for the customer. Additionally, the embodiments disclosed herein may include novel features, such as the integration of NFC technology with secure fingerprint ability, ECML compliant devices, and strong limitation of access to personal identification information due to the absence of a direct display in some embodiments.

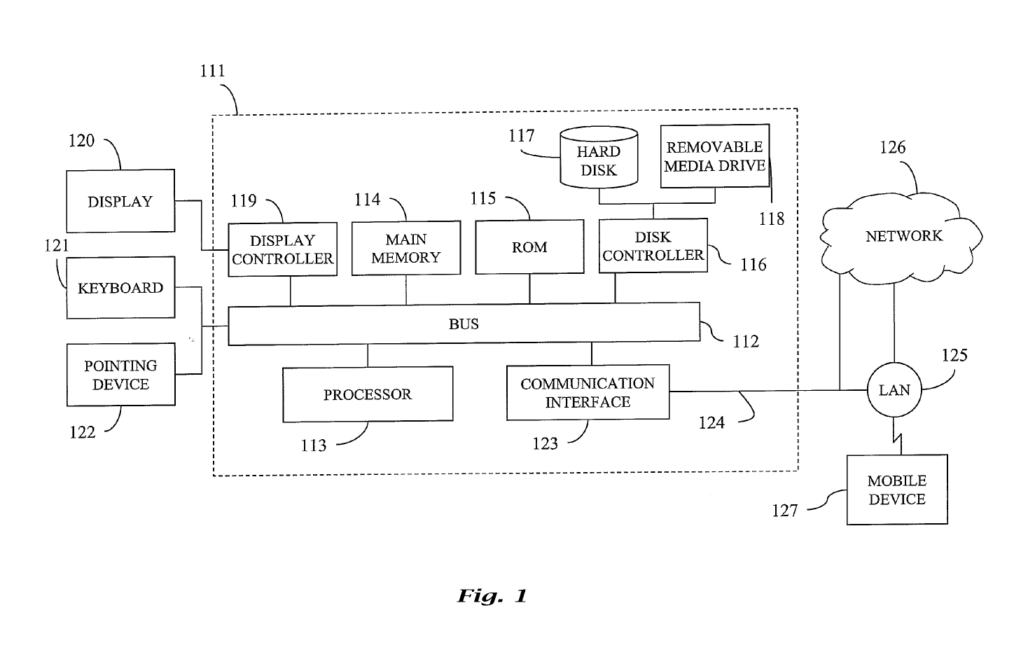

FIG. 1 illustrates a computer system 111 upon which an embodiment of the present invention may be implemented. The computer system 111 may include a bus 112 or other communication mechanism for communicating information, and a processor 113 coupled with the bus 112 for processing the information. The computer system 111 also may include a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 may further include a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 may also include a disk controller 116 coupled to the bus 112 to control one or more storage devices for storing information and instructions, such as a magnetic hard disk 117, and a removable media drive 118 (e.g., floppy disk drive, flash memory drive, read-only compact disc drive, read/write compact disc drive, compact disc jukebox, tape drive, and removable magneto-optical drive). The storage devices may be added to the computer system 111 using an appropriate device interface, including, for example, a small computer system interface (SCSI), integrated device electronics (IDE), enhanced-IDE (E-IDE), direct memory access (DMA), ultra-DMA, a serial port connection, a parallel port connection, USB, IEEE 1394 (FireWire), Bluetooth, Wi-Fi, or any other type of connection or interface known in the art.

The computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer user. The computer system may include input devices, such as a keyboard 121 and a pointing device 122, for interacting with a computer user and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 may perform a portion or all of the processing steps of exemplary embodiments of the invention in response to the processor 113 executing one or more sequences of one or more instructions contained in a memory, such as the main memory 114. Such instructions may be read into the main memory 114 from another computer-readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 may include at least one computer-readable medium or memory for holding instructions programmed according to the teachings of exemplary embodiments of the invention and for containing data structures, tables, records, or other data described herein. Examples of computer-readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer-readable media, exemplary embodiments of the present invention may include software for controlling the computer system 111, for driving a device or devices for implementing exemplary embodiments of the invention, and for enabling the computer system 111 to interact with a human user. Such software may include, but is not limited to, device drivers, operating systems, development tools, and applications software. Such computer-readable media may further include the computer program product of exemplary embodiments of the present invention for performing all or a portion (if processing is distributed) of the processing performed in implementing exemplary embodiments of the invention.

The computer code devices of exemplary embodiments of the present invention may be any interpretable or executable code mechanism, including but not limited to scripts, interpretable programs, dynamic link libraries (DLLs), Java classes, and complete executable programs. Moreover, parts of the processing of exemplary embodiments of the present invention may be distributed for better performance, reliability, and/or cost.

The term “computer-readable medium” as used herein refers to any medium that may participate in providing instructions to the processor 113 for execution. A computer-readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media may include dynamic memory, such as the main memory 114. Transmission media may include coaxial cables, copper wire and fiber optics, including the wires that make up the bus 112. Transmission media also may also take the form of acoustic or light waves, such as those generated during radio wave and infrared data communications. Transmission may be accomplished using, for example, a serial port connection, a parallel port connection, USB, TREE 1394 (FireWire), Bluetooth, Wi-Fi, or any other type of connection or interface known in the art.

Various forms of computer-readable media may be involved in carrying out one or more sequences of one or more instructions to processor 113 for execution. For example, the instructions may initially be carried on a magnetic disk of a remote computer. The remote computer can load the instructions for implementing all or a portion of exemplary embodiments of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 may carry the data to the main memory 114, from which the processor 113 may retrieve and execute the instructions. The instructions received by the main memory 114 may optionally be stored on storage device 117 or 118 either before or after execution by processor 113.

The computer system 111 may also include a communication interface 123 coupled to the bus 112. The communication interface 123 may provide a two-way data communication coupling to a network link 124 that may be connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links, using, for example, Wi-Fi or Bluetooth, may also be implemented. In any such implementation, the communication interface 123 may send and receive electrical, electromagnetic or optical signals that may carry digital data streams representing various types of information.

The network link 124 typically may provide data communication through one or more networks to other data devices. For example, the network link 124 may provide a connection to another computer or remotely located presentation device through a local network 125 (e.g., a LAN) or through equipment operated by a service provider, which may provide communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of exemplary embodiments of the invention may include data transmission and Internet-related activities. See Preston Gralla, How the Internet Works, Ziff-Davis Press (1996), which is hereby incorporated by reference into this patent application. Still other aspects of exemplary embodiments of the invention may utilize wireless data transmission, such as those described in U.S. Pat. Nos. 6,456,645, 5,818,328 and/or 6,208,445, all of which are hereby incorporated by reference into this patent application.

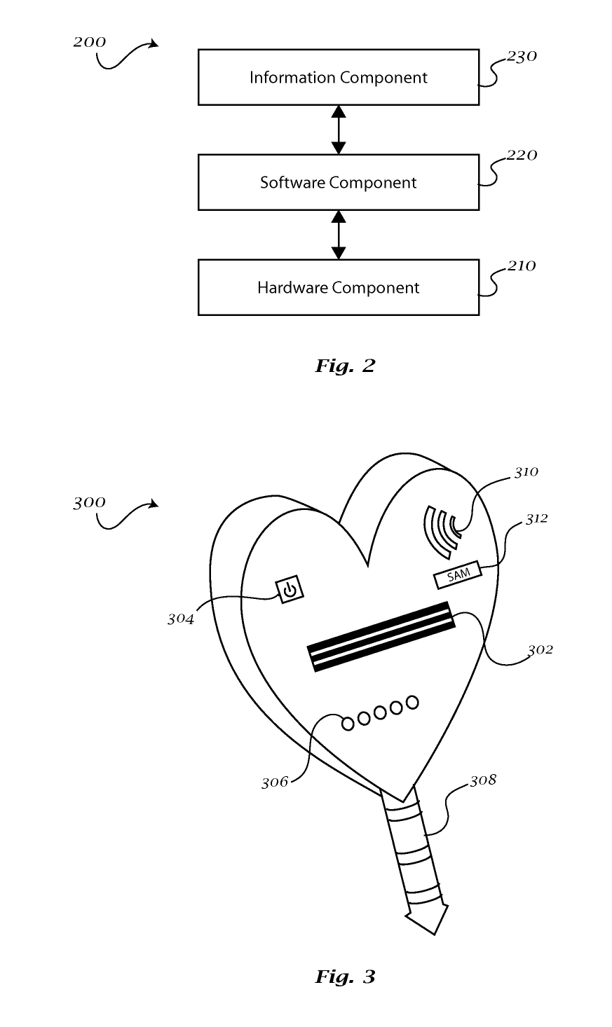

FIG. 2 shows an exemplary embodiment 200 of a system for facilitating transactions. The system may include a hardware component 210, a software component 220, and an information component 230. The software component 220 may run at least in part on the hardware component 210, and may be implemented, for example, to provide security and encryption for personal information and for an actual transaction. The information component 230 may be accessible to the software component 220.

FIG. 3 shows an exemplary embodiment 300 of a hardware component of a system for facilitating transactions. The hardware component may include a biometric fingerprint reader 302, a user-operable button 304, a plurality of LEDs 306, a connector 308, a wireless communication device 310, and a Secure Access Module (SAM) 312. The connector 308 may be a connector such as, for example, a TRS or a TRRS connector, or any other form of connector, as desired. The wireless communication device 310 may be, for example, an RFID read/write device or the like. The Secure Access Module (SAM) 312 may be used, for example, to enhance security and cryptography performance.

Alternatively, another exemplary embodiment of the hardware component may include at least one connector 308 but no wireless communication device 310. In still another exemplary embodiment, the hardware component may include at least one wireless communication device 310 but no connector 308.

Alternatively, another exemplary embodiment of the hardware component may further include at least one of a main processor, a battery, a charge indicator, a tamper detection mechanism, SRAM, flash memory, a hardware ID, a real-time clock, and erasable memory.

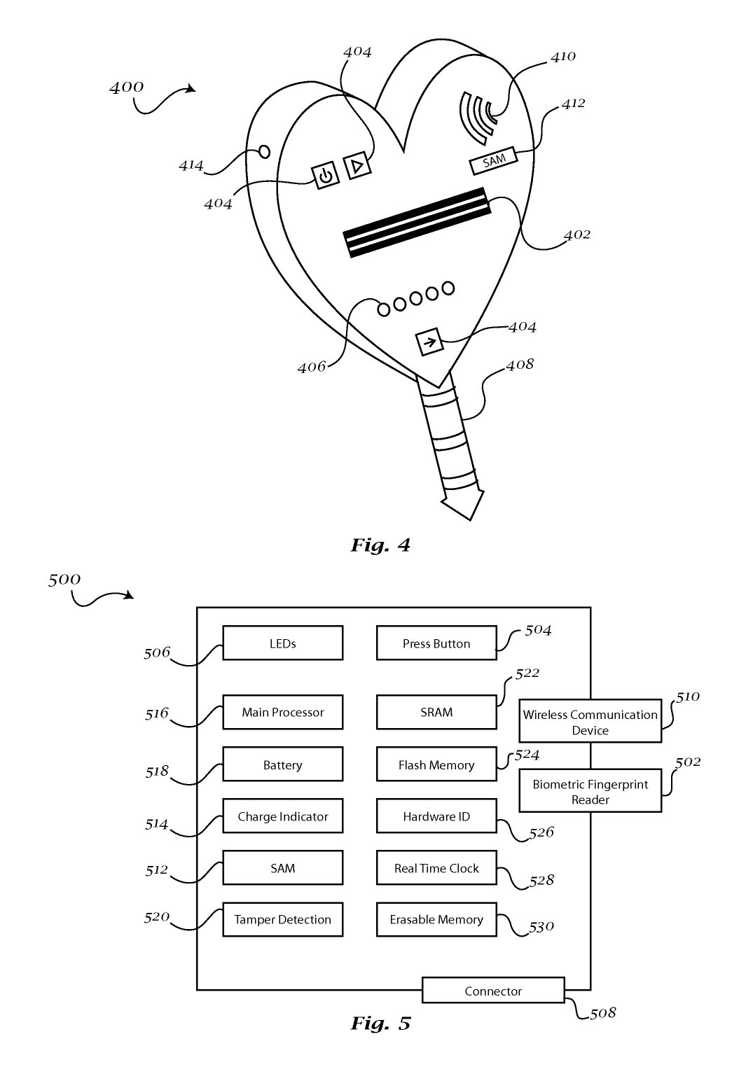

FIG. 4 illustrates another exemplary embodiment 400 of the hardware component of a system for facilitating transactions. Many components of embodiment 400 are the same or similar to those of embodiment 300, and are identified by similar numerals. Such components should be understood to have substantially similar characteristics and functionality in both embodiments. This exemplary embodiment may include a biometric fingerprint reader 402, a plurality of user-operable buttons 404, a plurality of LEDs 406, a connector 408, a wireless communication device 410, and a Secure Access Module (SAM) 412. This embodiment 400 may further include a charge indicator 414.

FIG. 5 shows yet another exemplary embodiment 500 of the hardware component of a system for facilitating transactions. Many components of embodiment 500 are the same or similar to those of embodiment 300, and are identified by similar numerals. Such components should be understood to have substantially similar characteristics and functionality in both embodiments. This exemplary embodiment may include a biometric fingerprint reader 502, a user-operable button 504, a plurality of indicator LEDs 506, a connector 508, a wireless communication device 510, a Secure Access Module (SAM) 512, a main processor 516, a battery 518, and a charge indicator 514. This embodiment 500 may further include a tamper detection mechanism 520, SRAM 522, flash memory 524, a hardware ID 526, a real-time clock 528, and erasable memory 530.

An exemplary embodiment of the software component of a system for facilitating transactions may include at least one of firmware, an operating system, a run-time system, a framework, an application programming interface (API), and a business application. The operating system may include, for example, a security service.

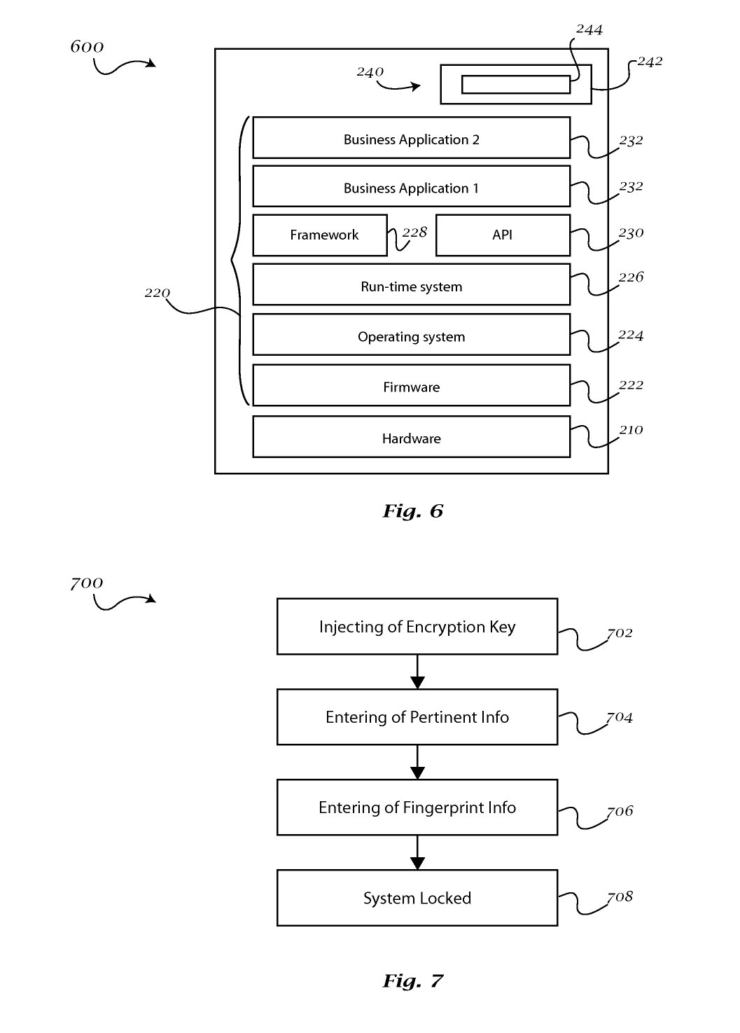

FIG. 6 shows the system architecture of an exemplary embodiment 600 of a system for facilitating transactions. The software component 220 may include firmware 222, an operating system 224, a run-time system 226, a framework 228, an application programming interface (API) 230, and business applications 232. In an exemplary embodiment, the operating system 224 may include a security service.

An exemplary embodiment of the information component 240 may include at least one database 242. A database 242 may contain business data 244. The database 242 may be used, for example, to store user-inputted information. The information component 240 may include a database 242, which may contain business data 244.

FIG. 7 shows an exemplary method 700 of setting up and locking a system for facilitating transactions. At step 702, an encryption key may be injected. At step 704, pertinent information may be entered. At step 706, fingerprint information may be entered. At step 708, the device may be locked.

The encryption key may be inaccessible, and may be systematically cleared if a tempering event occurs. Pertinent information may include, for example, information useful for a payment operation, such as, for example, sensitive data, and/or information useful for other wireless transactions. The information useful for a payment operation may include a unique and secure ID or any other information required for a payment, for example, as for a payment system that could be distributed by banks to their end customers as a particular payment system. It may also include payment card information, for example, to function as an equivalent or a substitute to an existing payment card or a set of existing payment cards. The information useful for other wireless transactions may include, for example, electronic ticketing information, electronic money information, travel card information, and/or identity document information.

Any or all desired pertinent information may be strongly encrypted for storage. Step 706 may include, for example, swiping a finger or a thumb. In an exemplary embodiment, the fingerprint reader may scan a finger or a thumb and may store data concerning distinctive portions of the fingerprint called “minutia points.” In some examples, a complete image of a fingerprint itself may therefore not be stored on a system. The minutia points can be a mathematical representation of some data from the original fingerprint. It may not be possible to reconstruct the fingerprint using these points. In addition, these templates may be encrypted when stored. The encryption of the templates may be an independent element and may thus not depend on the security software.

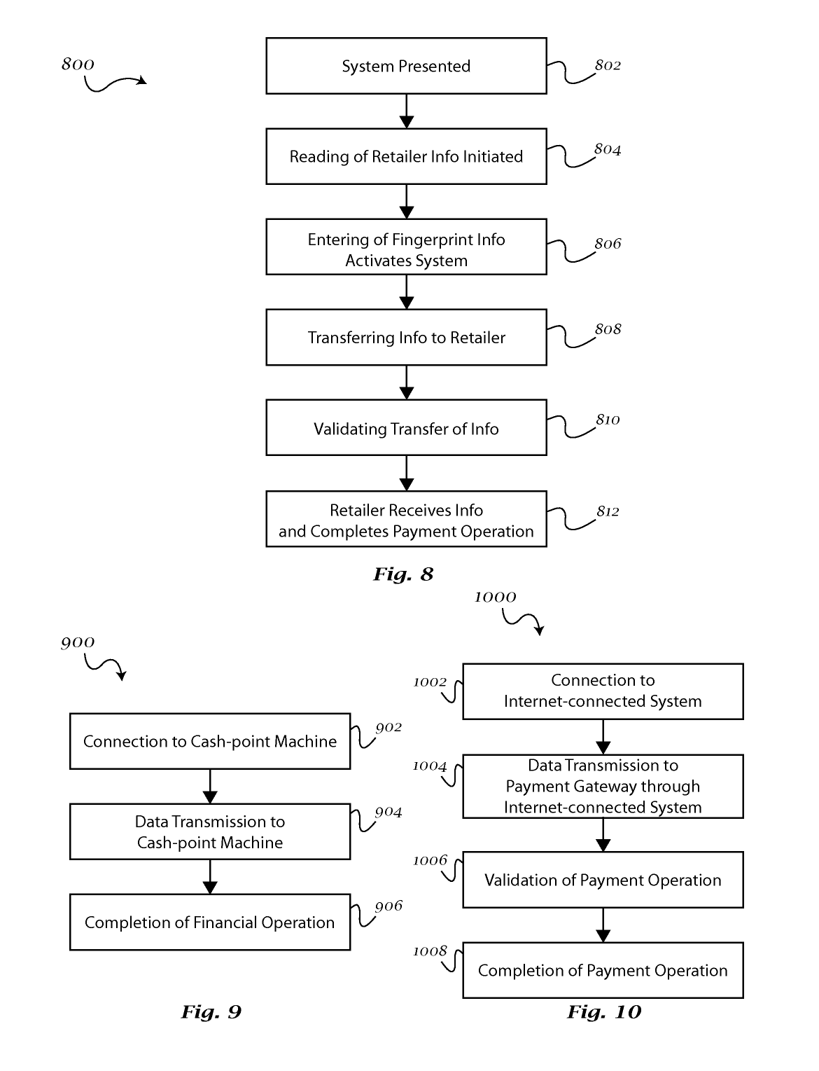

FIG. 8 shows an exemplary method 800 of performing a face-to-face payment operation from a customer to a retailer using a system for facilitating transactions. At step 802, the system may be presented to the retailer. A system for facilitating transactions may be presented, for example, for checkout. At step 804, the reading of information from a retailer system may be initiated. The retailer system may include at least one of a connector-compatible device and a wireless-enabled device. At step 806, the system may be activated by entering fingerprint information using the fingerprint reader. At step 808, information may be transferred to the retailer system. At step 810, the transfer of information to the retailer system may be validated. At step 812, the face-to-face payment operation may be completed.

FIG. 9 shows an exemplary method 900 of performing a financial operation at a cash point machine using system for facilitating transactions. The cash point machine may include at least one of a connector-compatible device and a wireless-enabled device. At step 902, the system may be connected to the cash point machine. At step 904, data transmission to the cash point machine may be activated by entering fingerprint information using the fingerprint reader. At step 906, the financial operation may be completed. The financial operation to be performed may include, for example, at least one of a cash withdrawal, a cash advance, and an account balance checking.

FIG. 10 shows an exemplary method 1000 of performing a payment operation on an Internet website payment gateway using an Internet-connected system and a system for facilitating transactions. Before step 1002, the customer may first validate for check-out after building his basket on a website. At step 1002, the system may be connected to the Internet-connected system. The Internet-connected system may include at least one of a connector-compatible device and a wireless-enabled device. At step 1004, data transmission to the payment gateway through the Internet-connected system may be activated by entering fingerprint information using the fingerprint reader. At step 1006, the payment operation may be validated. At step 1008, the financial operation may be completed. The Internet-connected system may be, for example, a personal computer, a smartphone or a tablet computer. After step 1008, the customer may get back the customer device for other usage.

In another exemplary embodiment, a system for facilitating transactions may enable a purchase over a telephone network.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for facilitating transactions comprising:
a hardware component comprising:
at least one biometric fingerprint reader;
at least one user-operable button;
a plurality of indicator LEDs;
at least one of a connector and a wireless communication device; and
at least one Secure Access Module;
a software component adapted to run on at least in part on the hardware component; and
an information component adapted to be accessed by the software component.

2. The system for facilitating transactions of claim 1, wherein the hardware component further comprises at least one of a main processor, a battery, a charge indicator, a tamper detection mechanism, SRAM, flash memory, a hardware ID, a real-time clock, and erasable memory.

3. The system for facilitating transactions of claim 1, wherein the software component comprises at least one of firmware, an operating system, a run-time system, a framework, an application programming interface, and a business application.

4. The system for facilitating transactions of claim 1, wherein the information component comprises at least one database.

5. A method for setting up and locking a system for facilitating transactions, comprising:
injecting an encryption key;
entering pertinent information;
entering fingerprint information; and
locking the system,
wherein the pertinent information comprises information utilized for at least one of a payment operation and a wireless transaction, and
wherein the system for facilitating transactions comprises:
a hardware component comprising:
at least one biometric fingerprint reader;
at least one user-operable button;
a plurality of indicator LEDs;
at least one of a connector and a wireless communication device; and
at least one Secure Access Module;
a software component adapted to run on at least in part on the hardware component; and
an information component adapted to be accessed by the software component.

6. The method for setting up and locking a system for facilitating transactions of claim 5, the hardware component further comprising at least one of a main processor, a battery, a charge indicator, a tamper detection mechanism, SRAM, flash memory, a hardware ID, a real-time clock, and erasable memory.

7. The method for setting up and locking a system for facilitating transactions of claim 5, the software component comprising at least one of firmware, an operating system, a run-time system, a framework, an application programming interface, and a business application.

8. The method for setting up and locking a system for facilitating transactions of claim 5, the information component comprising at least one database.

9. A method for performing a face-to-face payment operation from a customer to a retailer using a system for facilitating transactions, comprising:
presenting the system to the retailer;
initiating reading of information from a retailer system;
activating the system by entering fingerprint information using a fingerprint reader;
transferring information to the retailer system;
validating the transfer of information to the retailer system; and
completing the face-to-face payment operation,
wherein the retailer system includes at least one of a connector-compatible device and a wireless-enabled device, and
wherein the system for facilitating transactions comprises:
a hardware component comprising:
at least one biometric fingerprint reader;
at least one user-operable button;
a plurality of indicator LEDs;
at least one of a connector and a wireless communication device; and
at least one Secure Access Module;
a software component adapted to run on at least in part on the hardware component; and
an information component adapted to be accessed by the software component.

10. The method for performing a face-to-face payment operation from a customer to a retailer of claim 9, wherein the hardware component further comprises at least one of a main processor, a battery, a charge indicator, a tamper detection mechanism, SRAM, flash memory, a hardware ID, a real-time clock, and erasable memory.

11. The method for performing a face-to-face payment operation from a customer to a retailer of claim 9, wherein the software component comprises at least one of firmware, an operating system, a run-time system, a framework, an application programming interface, and a business application.

12. The method for performing a face-to-face payment operation from a customer to a retailer of claim 9, wherein the information component comprises at least one database.

13. A method for performing a financial operation at a cash point machine using a system for facilitating transactions, comprising:
connecting the system to the cash point machine;
activating data transmission to the cash point machine by entering fingerprint information using a fingerprint reader; and
completing the financial operation,
wherein the cash point machine includes at least one of a connector-compatible device and a wireless-enabled device, and
wherein the system for facilitating transactions comprises:
a hardware component comprising:
at least one biometric fingerprint reader;
at least one user-operable button;
a plurality of indicator LEDs;
at least one of a connector and a wireless communication device; and
at least one Secure Access Module;
a software component adapted to run on at least in part on the hardware component; and
an information component adapted to be accessed by the software component.

14. The method for performing a financial operation at a cash point machine of claim 14, wherein the hardware component further comprises at least one of a main processor, a battery, a charge indicator, a tamper detection mechanism, SRAM, flash memory, a hardware ID, a real-time clock, and erasable memory.

15. The method for performing a financial operation at a cash point machine of claim 14, wherein the software component comprises at least one of firmware, an operating system, a run-time system, a framework, an application programming interface, and a business application.

16. The method for performing a financial operation at a cash point machine of claim 14, wherein the information component comprises at least one database.

17. A method for performing a payment operation on an Internet website payment gateway using an Internet-connected system and a system for facilitating transactions, comprising:
connecting the system to the Internet-connected system;
activating data transmission to the payment gateway through the Internet-connected system by entering fingerprint information using a fingerprint reader;
validating the payment operation; and
completing the financial operation,
wherein the Internet-connected system includes at least one of a connector-compatible device and a wireless-enabled device, and
wherein the system for facilitating transactions comprises:
a hardware component comprising:
at least one biometric fingerprint reader;
at least one user-operable button;
a plurality of indicator LEDs;
at least one of a connector and a wireless communication device; and
at least one Secure Access Module;
a software component adapted to run on at least in part on the hardware component; and
an information component adapted to be accessed by the software component.

18. The method for performing a payment operation on an Internet website payment gateway of claim 17, wherein the hardware component further comprises at least one of a main processor, a battery, a charge indicator, a tamper detection mechanism, SRAM, flash memory, a hardware ID, a real-time clock, and erasable memory.

19. The method for performing a payment operation on an Internet website payment gateway of claim 17, wherein the software component comprises at least one of firmware, an operating system, a run-time system, a framework, an application programming interface, and a business application.

20. The method for performing a payment operation on an Internet website payment gateway of claim 17, wherein the information component comprises at least one database.
